(19) United States
(12) Patent Application Publication
(10) Pub. No.: US 2001/0013735 A1
(43) Pub. Date: Aug. 16, 2001

(54) Motor with dynamic pressure bearings

(76) Inventors: Yoshiharu Terawaki, Suwa-gun (JP); Yasushi Mizusaki, Suwa-gun (JP)

Correspondence Address: HOGAN & HARTSON L.L.P., 500 S. GRAND AVENUE, SUITE 1900, LOS ANGELES, CA, 90071-2611, US

(21) Appl. No.: 09/771,109

(22) Filed: Jan. 26, 2001

(30) Foreign Application Priority Data
Jan. 28, 2000 (JP) 2000-020883

(51) Int. Cl. H02K 7/09

(52) U.S. Cl. 310/90.5

(57) ABSTRACT

A motor with dynamic pressure bearing has a radial dynamic pressure bearing section in which opposing radial dynamic pressure surfaces are formed on a rotor and a stator such that a dynamic pressure is generated in a lubrication fluid between the radial dynamic pressure surfaces to thereby rotatably support the rotor in a radial direction thereof with respect to the stator. The motor has thrust magnets mounted on the rotor and the stator in a manner to oppose to one another for generating a magnetic action to levitate the rotor in an axial direction thereof and rotatably support the rotor in a thrust direction thereof with respect to the stator. A magnetic shield device is provided between the thrust magnets and the radial dynamic pressure bearing section for isolating the radial dynamic pressure bearing section from a leak magnetic flux of the thrust magnets.

### BACKGROUND OF THE INVENTION

1. Field of the Invention

The present invention relates to a motor with dynamic pressure bearings and a method for operating the same in which a rotor is supported in a radial direction by a dynamic pressure bearing section with respect to a stator and in a thrust direction by a magnetic action of a thrust magnet unit.

2. Description of Related Art

Motors equipped with dynamic pressure bearing units are widely used in apparatuses that rotate rotating bodies such as polygon mirrors, magnetic discs, optical discs and the like at high speeds.

For example, FIG. 4 shows a dynamic pressure bearing unit that is used in a drive motor for driving a polygon mirror 1. The drive motor has a stator 2, a fixed shaft 2a that forms the stator 2, a rotor 3, and a bearing sleeve 3a that forms the rotor 3. A dynamic pressure surface is provided on an outer periphery of the fixed shaft 2a, and another dynamic pressure surface is provided on the bearing sleeve 3a. The dynamic pressure surfaces are disposed opposite to each other with a small gap provided between the dynamic pressure surfaces in a radial direction thereof. A lubrication fluid, such as, for example, air, oil or the like (not shown) is provided in the gap between the opposing dynamic pressure surfaces. The lubrication fluid is pressurized by a pumping action that is caused by dynamic pressure generation grooves (not shown) formed in at least one of the opposing dynamic pressure surfaces to generate a dynamic pressure in the lubrication fluid. The entire rotor 3 is rotatably supported in a radial direction by the dynamic pressure with respect to the stator 2.

On the other hand, a recessed section is formed in an upper end portion of the fixed shaft 2a that forms the stator 2, as shown in the figure. A ring-shaped fixed-side thrust magnet 2b is mounted on an internal peripheral surface of the recessed section. A polygon mirror-affixing member 3b is mounted on a top portion of the rotor 3. Rotating-side thrust magnets 3c are disposed on the polygon mirror-affixing member 3b in a manner to oppose to an internal peripheral surface of the fixed-side thrust magnet 2b. The thrust magnets 2b and 3c are respectively magnetized in an axial direction thereof (in an up-to-down direction in the figure) in order to attract (or repel to) one another in the axial direction. The rotor 3 is levitated in the axial direction and rotatably supported in a thrust direction with respect to the stator 2 by the magnetic attraction action of the thrust bearings 2b and 3c.

However, in the motor with dynamic pressure bearings having the thrust magnets 2b and 3c described above, the thrust magnets 2b and 3c and the radial dynamic pressure bearing sections may be disposed very close to one another when the motor is further reduced in size and thickness. As a result, a leak magnetic flux φ from the thrust magnet 2b may reach the radial dynamic pressure bearing section, as shown in FIG. 5, and a magnetic field may be formed by the leak magnetic flux within the dynamic pressure bearing section. As a result, foreign matters, that may exist outside the dynamic pressure bearing section, are attracted to surfaces inside the dynamic pressure bearing section. If the attracted foreign matters are hard, the foreign matters may damage or scrape the surfaces of the fixed shaft 2a and the bearing sleeve 3a, which may result in noises and burns.

### SUMMARY OF THE INVENTION

In view of the above, it is an object of the present invention to provide a motor with dynamic pressure bearing that can isolate a dynamic pressure bearing section from leak magnetic fluxes of thrust bearings and prevent damage and scratches on surfaces of a fixed shaft and a bearing sleeve.

To achieve the object described above, a motor with dynamic pressure bearings in accordance with one embodiment of the present invention comprises a radial dynamic pressure bearing section, a thrust magnet section for magnetically support a rotor with respect to a stator, and a magnetic shield device provided between the thrust magnet section and the radial dynamic pressure bearing section for isolating the radial dynamic pressure bearing section from a leak magnetic flux of the thrust magnet section.

In accordance with one embodiment, a motor with dynamic pressure bearings has a rotor unit, a stator unit and a radial dynamic pressure bearing section having opposing radial dynamic pressure surfaces that are formed on the rotor unit and the stator unit. As the rotor unit is rotated, a dynamic pressure is generated in a lubrication fluid filled in a gap between the radial dynamic pressure surfaces to thereby rotatably support the rotor unit in a radial direction thereof with respect to the stator. Thrust magnets are mounted on the rotor unit and the stator unit in a manner to oppose to one another for generating a magnetic action to levitate the rotor in an axial direction thereof and rotatably support the rotor in a thrust direction thereof with respect to the stator. A magnetic shield device is provided between the thrust magnets and the radial dynamic pressure bearing section for isolating the radial dynamic pressure bearing section from a leak magnetic flux of the thrust magnets.

By isolating the leak magnetic flux from the thrust magnets by the magnetic shield device, the magnetic flux is prevented from leaking into the radial dynamic pressure bearing section, and therefore an undesired attraction magnetic field is prevented from being formed within the radial dynamic pressure bearing section. As a result, foreign matters, that may exist outside the dynamic pressure bearing section, can be prevented from being attracted to the dynamic pressure bearing section.

The magnetic shield device may be formed form a magnetic absorbing member that absorbs the leak magnetic flux from the thrust magnetic bearings. The magnetic absorbing member may be formed from a yolk member having a magnetic permeability greater than a magnetic permeability of a mounting member on which the thrust magnets are mounted. Also, the magnetic shield device may be formed from an insertion member that spaces a distance between the thrust magnets and the radial dynamic pressure bearing section.

Also, in accordance with the present invention, the thrust magnets may be disposed inside the radial dynamic pressure bearing section in the radial direction, and the magnetic shield device may be disposed between the thrust magnets and the radial dynamic pressure bearing section in the radial direction. As a result, the bearing apparatus can be reduced in size, and the magnetic flux of the thrust magnets is prevented from leaking into the radial dynamic pressure bearing section, and an unnecessary attracting magnetic flux is prevented from being formed within the radial dynamic pressure bearing section.

In accordance with one embodiment of the present invention, the stator may include a fixed shaft, the rotor may be disposed about an outer periphery of the fixed shaft, and a bearing sleeve that forms the radial dynamic pressure bearing section may be disposed between the fixed shaft and the rotor. The thrust magnets may be mounted inside the fixed shaft and inside the radial dynamic pressure bearing section in the radial direction. As a result, when a thrust bearing section of the thrust magnets and the radial dynamic pressure bearing section may be overlapped in the axial direction to reduce the measurements of the motor in the radial direction, the magnetic flux is prevented from leaking into the radial dynamic pressure bearing section, and an unnecessary attracting magnetic flux is prevented from being formed within the radial dynamic pressure bearing section.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a partially broken side view of a motor with dynamic pressure bearings for driving a polygon mirror in accordance with one embodiment of the present invention.

FIG. 2 shows an enlarged cross-sectional view of a main portion of the motor shown in FIG. 1.

FIG. 3 shows an enlarged cross-sectional view of a main portion of a motor in accordance with another embodiment of the present invention.

FIG. 4 shows a partially broken side view of a conventional motor with dynamic pressure bearings for driving a polygon mirror.

FIG. 5 shows an enlarged cross-sectional view of a main portion of the motor shown in FIG. 4.

### PREFERRED EMBODIMENTS OF THE INVENTION

Embodiments of the present invention are described below. First, a fixed shaft type polygon mirror driving motor with air dynamic pressure bearings in accordance with an embodiment of the present invention is described below with reference to the accompanying drawings.

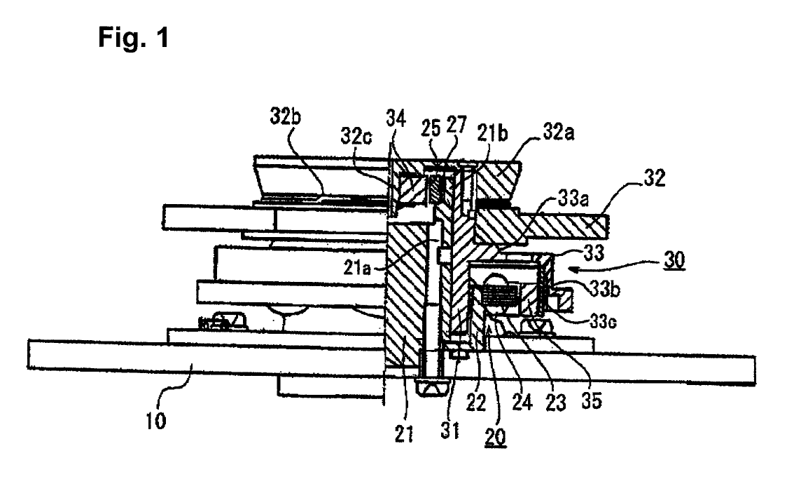

FIG. 1 shows a motor for rotating a polygon mirror, which is one example of a fixed shaft type outer rotor motor that is equipped with an air dynamic pressure bearing apparatus. The motor is formed from a stator assembly 20 that defines a fixed member mounted on a frame 10 and a rotor assembly 30 that defines a rotating member that is coupled over the stator assembly 20 from above in the figure. The stator assembly 20 has a fixed shaft (shaft member) 21 extending generally from the center of the frame 10 and a cylindrical bearing holder 22 disposed about the fixed shaft 21. The cylindrical bearing holder 22 is separated in a radial direction from an external peripheral surface of the fixed shaft 21 by a specified distance. Stator cores 23 are affixed on the outer periphery of the bearing holder 22. A driving coil 24 is wound around a salient pole section of each of the stator cores 23.

A base member of the fixed shaft 21 is formed from an aluminum material such as aluminum or an aluminum alloy. A lubricating resin coating is formed over an external surface of the fixed shaft 21 by an electrodeposition paining method or the like to define a radial dynamic pressure bearing surface. For example, herringbone radial dynamic pressure generation grooves (not shown) that are divided in two blocks in the axial direction are formed on the external peripheral surface of the fixed shaft 21 coated with the lubricating resin coating to thereby form a dynamic pressure bearing section on the side of the fixed shaft 21. A bearing sleeve 31 of the rotor assembly 30 is rotatably disposed outside the fixed shaft 21 having the dynamic pressure generation grooves. The bearing sleeve 31 is separated from the fixed shaft 21 by several μm to several ten μm.

The bearing sleeve 31 is formed from an aluminum material such as aluminum or an aluminum alloy. A plated layer is formed on an internal peripheral surface of the bearing sleeve 31 to define a radial dynamic pressure bearing surface on the rotor side. In this manner, a radial dynamic pressure bearing section that generates air dynamic pressure is formed between the external peripheral surface of the fixed shaft 21 and the internal peripheral surface of the bearing sleeve 31.

Furthermore, a polygon mirror 32 having a hexagonal shape in plan view is coupled onto the external periphery of the bearing sleeve 31. A retaining plate 33a that is defined by a part of a rotor body section 33 extends outwardly in the radial direction from the bearing sleeve 31. The polygon mirror 32 is fixedly mounted on the retaining plate 33a by clamping a central portion of an upper surface of the polygon mirror 32 in the axial direction by a clamp member 32a that is mounted on the bearing sleeve 31. The polygon mirror 32 is clamped by the clamp member 32a with a retaining spring 32b being interposed in an outer peripheral area of the clamp member 32a between the polygon mirror 32 and the clamp member 32a.

An external peripheral wall section 21b is formed in the shape of a ring at a top portion (i.e., an upper end section in the figure) of the fixed shaft 21. The external peripheral wall section 21b extends by a specified amount in the axial direction (upwardly in the figure). Fixed-side thrust magnets 25 for levitation in the thrust direction are mounted on an internal periphery of the external peripheral wall section 21b. The fixed-side thrust magnets 25 are magnetized in the axial direction (in the up-to-down direction in the figure).

An air orifice 32c of a small diameter extends in the axial direction through the clamp member 32a at a center thereof. A rotor-side thrust magnet 34 in the shape of a ring for levitation in the thrust direction is mounted in a manner to encircle the air orifice 32c. The rotor-side thrust magnet 34 is disposed in a manner to oppose in the radial direction to the fixed-side thrust magnets 25. The rotor-side thrust magnet 34 is magnetized in the axial direction (in the up-to-down direction in the figure) such that a magnetic attraction force or a magnetic repelling force is generated between the thrust magnet 34 and the thrust magnets 25. The entire rotor assembly 30 is levitated by a specified amount in the thrust direction with respect to the stator assembly 20 by the mutual magnetic action between the thrust magnet 34 and the thrust magnets 25. In this manner, the thrust magnet 34 and the thrust magnets 25 thus structured form a thrust bearing.

The air orifice 32c provided at the center of the clamp member 32a is a through hole of a small diameter that extends in the axial direction and works as a damper having a flow resistance. Movements of the rotor assembly 30 or impacts on the rotor assembly 30 in the axial direction are damped by the damper action caused by the flow resistance of the air orifice 32c.

Also, an air supply hole 21a that opens to and communicates with the upper end section of the fixed shaft 21 is provided within the fixed shaft 21. An intermediate portion of the air supply hole 21a opens to and communicates with the outside of the fixed shaft 21. In other words, the intermediate portion of the air supply hole 21a opens to and communicates with an intermediate section of the upper and lower radial dynamic pressure bearing sections arranged in the axial direction. Air within the rotor assembly 30 is supplied through the air supply hole 21a to the two radial dynamic pressure bearing sections. The air flows upwardly and downwardly in the axial direction by the pumping action of the dynamic pressure generation grooves.

The rotor body section 33 is formed from a generally cylindrical member that is formed with the bearing sleeve 31 in one piece. The rotor body section 33 separates a rotor interior space in which the driving coils 24 are disposed from a rotor exterior space in which the polygon mirror 32 is disposed. A cylindrical mounting plate 33b is provided at an outer peripheral edge section of the rotor body section 33. Drive magnets 35 are attached circularly on an internal wall surface of the cylindrical mounting plate 33b through a back yolk 33c of a magnetic material. The drive magnets 35 are disposed in close proximity and opposing to the salient poles of the respective stator cores 23 to thereby form a motor drive section.

When a specified drive voltage is applied to the driving coils 24, the polygon mirror 32 rotates with the bearing sleeve 31. A laser beam reflected by the polygon mirror 32 is scanned across an image recording medium (not shown) as the polygon mirror 32 is rotated. The bearing sleeve 31 is supported in the radial direction by an air dynamic pressure generated between the bearing sleeve 31 and the fixed shaft 21, and the rotor assembly 30 is maintained by the mutual magnetic action between the rotor-side thrust magnets 34 and the fixed-side thrust magnets 25 in a state in which the entire rotor assembly 30 is levitated in the thrust direction with respect to the stator assembly 20

To reduce the size of the motor in the axial direction, the fixed-side thrust magnets 25 are mounted on the inside of the external peripheral wall section 21b of the fixed shaft 21 through a ring-shaped yolk member 27 for magnetic absorption. The external surface of the external peripheral wall section 21b of the fixed shaft 21 defines a bearing surface that forms the radial dynamic pressure bearing section. The ring-shaped yolk member 27 is disposed in a manner to cover the entire external peripheral surfaces of the fixed-side thrust magnets 25. The ring-shaped yolk member 27 has a function to absorb and isolate the leak magnetic flux φ radiating from the fixed-side thrust magnets 25 toward the radial dynamic pressure bearing section that is located outside the fixed-side thrust magnets 25. In other words, the ring-shaped yolk member 27 forms a magnetic shield between the fixed-side thrust magnets 25 and the radial dynamic pressure bearing section. The ring-shaped yolk member 27 is formed from a material having a greater magnetic permeability than that of the fixed shaft 21 that is a mounting member on which the ring-shaped yolk member 27 is mounted. For example, the ring-shaped yolk member 27 may be formed from a magnetic material such as iron or the like.

By the motor with dynamic pressure bearings having the structure described above in accordance with the present embodiment, the radial dynamic pressure bearing surface that is located outside the fixed-side thrust magnets 25 is isolated from the leak magnetic flux φ of the fixed-side thrust magnets 25 by the magnetic shield that is formed from the ring-shaped yolk member 27 even when the motor with dynamic pressure bearings is reduced in size in the axial direction and/or the radial direction. As a result, the magnetic flux is prevented from leaking into the dynamic pressure bearing section, and an unnecessary magnetic field is not formed within the dynamic pressure bearing section. Therefore, foreign matters, which may exist outside the dynamic pressure bearing section, are not attracted to the inside of the dynamic pressure bearing section. Surfaces of the fixed shaft 21 and the bearing sleeve 31 are prevented from damages and scrapes when the motor is rotated.

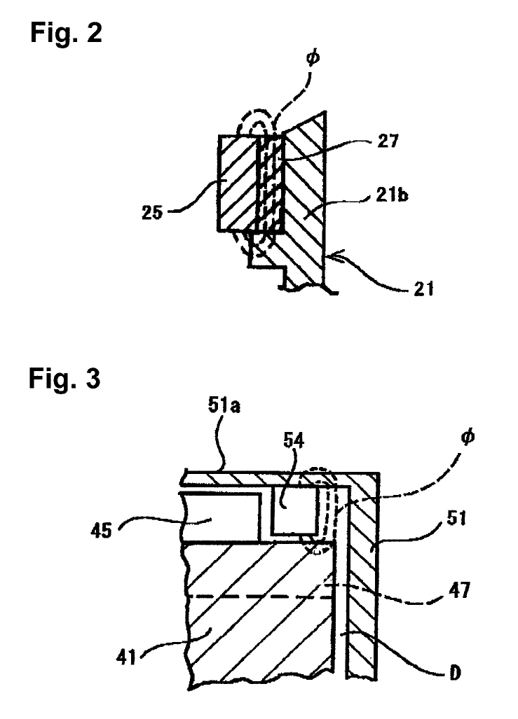

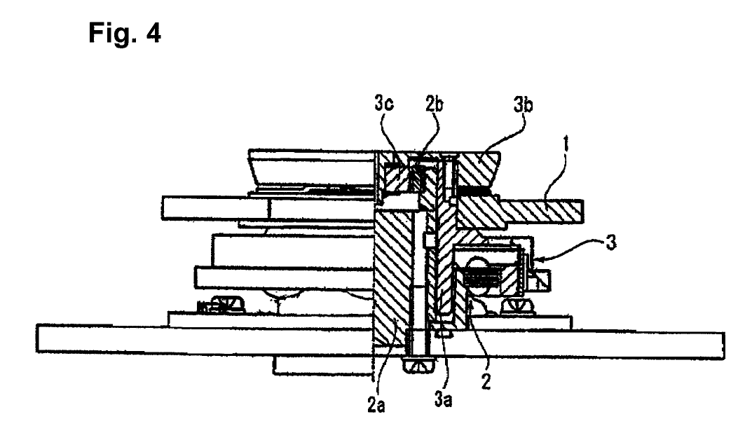

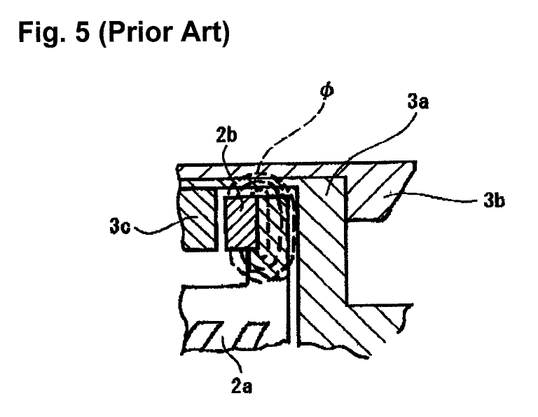

It is noted that, in the example shown in FIG. 2, the fixed-side thrust magnets 25 and the ring-shaped yolk member 27 have the same size in the axial direction. However, one of the fixed-side thrust magnets 25 and the ring-shaped yolk member 27 can have a size greater or smaller than the other depending on measurements or characteristics of other parts of the motor.

Next, FIG. 3 shows another embodiment. In the embodiment shown in FIG. 3, a fixed-side thrust magnet 45 is mounted on the top end portion of the fixed shaft 41 in a central area thereof. Rotor-side thrust magnets 54 are disposed on an internal surface (i.e., an internal lower surface as shown in the figure) of an upper closed wall 51a of a bearing sleeve 51 in a manner to circularly encircle an external peripheral surface of the fixed-side thrust magnet 45. An insertion member 47 is formed with the fixed shaft 41 in one piece between these fixed-side thrust magnet 45 and the rotor-side thrust magnets 54 and a dynamic pressure bearing section D. The insertion member 47 is provided as a magnetic shield device. The fixed-side thrust magnet 45 and the rotor-side thrust magnets 54 are separated from the dynamic pressure bearing section D by a distance that corresponds to the thickness of the insertion member 47 in the axial direction.

Also, the fixed-side thrust magnet 45 is directly mounted on the fixed shaft 41 in the center of the fixed shaft 41 that has the dynamic pressure surface. As a result, the fixed-side thrust magnet 45 is spaced a distance in the radial direction from the dynamic pressure bearing section.

In the present embodiment, a leak magnetic flux φ from the fixed-side thrust magnet 45 and the rotor-side thrust magnets 54 is isolated by the insertion member 47 from the dynamic pressure bearing section D. As a result, the present embodiment provides the same action and effects as those obtained by the aforementioned embodiment.

Some of the embodiments of the present invention are described above. However, the present invention is not limited to the embodiments described above and many modifications can be made without departing the subject matter of the present invention.

For example, in each of the embodiments described above, the positional relations and the configurations of the fixed-side thrust magnets and the rotor-side thrust magnets can be mutually inverted.

Also, in the embodiments described above, the dynamic pressure bearing apparatuses use air as a lubrication fluid. However, the present invention is also applicable to dynamic pressure bearing apparatuses that use another dynamic pressure fluid such as oil or the like.

Furthermore, the present invention is also applicable to motors other than the polygon mirror rotating motor, such as, for example, hard disc driving (HDD) motors and the like.

By the motors with dynamic pressure bearings in accordance with the present invention described above, a leak magnetic flux from the thrust magnets is isolated by a magnetic shield device such as a magnetic absorption member or an insertion member such as a yolk member. As a result, he magnetic flux is prevented from leaking into a radial dynamic pressure bearing section, and therefore an undesired attraction magnetic field is prevented from being formed within the radial dynamic pressure bearing section. Therefore, foreign matters, which may exist outside the dynamic pressure bearing section, do not enter the dynamic pressure bearing section or adhere to surfaces inside of the dynamic pressure bearing section. As a result, surfaces of the shaft member and the bearing member are prevented from damages and scrapes when the motor is rotating. Accordingly, very reliable motors with dynamic pressure bearings that have a long service life can be obtained with a relatively simple mechanical structure.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a radial dynamic pressure bearing section, the radial dynamic pressure bearing section including opposing radial dynamic pressure surfaces formed on a rotor and a stator in which a dynamic pressure is generated in a lubrication fluid between the radial dynamic pressure surfaces to thereby rotatably support the rotor with respect to the stator;
thrust magnets mounted on the rotor and the stator in a manner to oppose to each other for generating a magnetic action to levitate the rotor in an axial direction thereof and rotatably support the rotor in a thrust direction thereof with respect to the stator; and
a magnetic shield device provided between the thrust magnets and the radial dynamic pressure bearing section for isolating the radial dynamic pressure bearing section from a leak magnetic flux of the thrust magnets.

2. A motor according to claim 1, wherein the magnetic shield device is formed form a magnetic absorbing member that absorbs the leak magnetic flux from the thrust magnetic bearings.

3. A motor according to claim 2, wherein the magnetic absorbing member is formed from a yolk member having a magnetic permeability greater than a magnetic permeability of a mounting member provided on at least one of the rotor and the stator on which the thrust magnets are mounted.

4. A motor according to claim 1, wherein the magnetic shield device comprises an insertion member that spaces a distance between the thrust magnets and the radial dynamic pressure bearing section, and the insertion member is formed in one piece with a mounting member provided on at least one of the rotor and the stator on which the thrust magnets are provided.

5. A motor according to claim 1, wherein the rotor is an outer rotor type in which the rotor is disposed outside the stator in a radial direction thereof.

6. A motor according to claim 1, wherein the thrust magnets are disposed inside the radial dynamic pressure bearing section in the radial direction, and the magnetic shield device is disposed between the thrust magnets and the radial dynamic pressure bearing section in the radial direction to prevent the magnetic flux of the thrust magnets from affecting the radial dynamic pressure bearing section.

7. A motor according to claim 6, wherein the stator has a fixed shaft, the rotor is disposed about an outer periphery of the fixed shaft, a bearing sleeve that forms the radial dynamic pressure bearing section is disposed between the fixed shaft and the rotor, and the thrust magnets are mounted inside the fixed shaft and inside the radial dynamic pressure bearing section.

8. A motor according to claim 7, the lubrication fluid is one selected from a group consisting of air and oil.

9. A motor having a rotor and a stator, the motor comprising:
a radial dynamic pressure bearing section formed between the rotor and the stator;
a thrust magnet unit formed on the rotor and the stator for generating a magnetic action to levitate the rotor in an axial direction thereof and rotatably support the rotor in a thrust direction thereof with respect to the stator; and
a magnetic shield device provided between the thrust magnet unit and the radial dynamic pressure bearing section for isolating the radial dynamic pressure bearing section from a leak magnetic flux of the thrust magnet unit.

10. A motor according to claim 9, wherein the magnetic shield device is formed form a magnetic absorbing member that absorbs the leak magnetic flux from the thrust magnetic bearing unit.

11. A motor according to claim 10, wherein the thrust magnet unit includes magnets mounted on mounting members formed on the rotor and the stator, and the magnetic absorbing member is formed from a yolk member having a magnetic permeability greater than a magnetic permeability of at least one of the mounting members provided on at least one of the rotor and the stator on which the thrust magnets are mounted.

12. A motor according to claim 9, wherein the magnetic shield device comprises an insertion member that spaces a distance between the thrust magnet unit and the radial dynamic pressure bearing section, and the insertion member is provided on a mounting member that is integrally formed with at least one of the rotor and the stator on which the thrust magnet unit is formed.

13. A motor according to claim 9, wherein the rotor is an outer rotor type in which the rotor is disposed outside the stator in a radial direction thereof.

14. A motor according to claim 9, wherein the thrust magnet unit includes thrust magnets that are disposed inside the radial dynamic pressure bearing section in the radial direction, and the magnetic shield device is disposed between the thrust magnets and the radial dynamic pressure bearing section in the radial direction to prevent a magnetic flux of the thrust magnets from reaching the radial dynamic pressure bearing section.

15. A motor according to claim 14, wherein the stator has a fixed shaft, the rotor is disposed about an outer periphery of the fixed shaft, a bearing sleeve that forms the radial dynamic pressure bearing section is disposed between the fixed shaft and the rotor, and the thrust magnets are mounted inside the fixed shaft and inside the radial dynamic pressure bearing section in the radial direction thereof.
